(19) United States
(12) Patent Application Publication
(10) Pub. No.: US 2026/0328997 A1
(43) Pub. Date: Oct. 22, 2026

(54) IMAGE GUIDE DEVICE FOR IMAGE TRANSMISSION TO AN IMAGE CAPTURE DEVICE AND METHOD FOR MANUFACTURING AND REGENERATING THE IMAGE GUIDE DEVICE

(71) Applicant: Max-Planck-Gesellschaft zur Foerderung der Wissenschaften e. V., Muenchen (DE)

(72) Inventors: Manfred SOCHOR, Garching (DE); Volker ROHDE, Garching (DE); Gregor BIRKENMEIER, Garching (DE); Karlheinz KAUNERT, Garching (DE)

(21) Appl. No.: 19/115,773

(22) PCT Filed: Sep. 26, 2023
(86) PCT No.: PCT/EP2023/076525

§ 371 Date: Mar. 26, 2025

(30) Foreign Application Priority Data
Sep. 29, 2022 (EP) 22198642.5

(51) Int. Cl. G02B 6/06; G02B 7/00; G21C 17/08

(52) U.S. Cl. CPC G02B 6/06; G02B 7/008; G21C 17/08

(57) ABSTRACT

An image guide device (1) configured for image transmission (2) to an image capture device (4), includes a fiber optic bundle (5) configured for image transmission (2) and connected to two connectors (6), each arranged at one end of the fiber optic bundle (5), and a guide sheath (7) surrounding the fiber optic bundle (5) and extending between the connectors (6), wherein a heating conductor device (8) including at least one heating conductor (9), is provided for heating the fiber optic bundle (5) along its length to a predetermined treatment temperature so that, by heating to the treatment temperature, radiation-induced material defects in the fiber optic bundle (5) can be reduced. In addition, a method for manufacturing the image guide device (1) and a method for regenerating the image guide device (1) are described.

The invention relates to an image guide device configured for image transmission, for example, from a reaction area to a capture device, a method for manufacturing the image guide device, and a method for regenerating the image guide device to reduce radiation-induced defects. Applications of the invention are given, for example, in the monitoring of a combustion chamber of a fusion reactor, of a nuclear fission reactor, or of a neutron source, in medical technology, in particular radiology, or in the operation of MRI or X-ray devices.

It is known that image guides are used for image transmission from environments with high radiation exposure, which could cause damage or even destruction of unprotected electronic components. The image guide, which is made, for example, of flexible optical fibers, guides the image received by an unprotected objective lens at one end of the image guide in an area with harmful radiation to a camera located at the other end of the image guide. The camera may be located in a radiation-protected environment, e.g., a housing. An example of image transmission from a tokamak reactor is described by B. Chektybayev et al. in “Rev. Sci. Instrum.” 86, 053505(2015).

As the image guide is exposed to radiation largely unprotected, defects may occur in the structure of the image guide material due to interaction with high-energy photons, electrons, or neutrons. These defects cause, for example, a discoloration and/or darkening of the originally transparent material of the optical fiber guides so that the light transmission through the image guide is significantly reduced. It is described by C. P. Chrobak et al. in “Rev. Sci. Instrum.” 83, 10E514(2012) that heating the optical fiber guides to a temperature of a few 100 °C may at least partially reverse the formation of the defects induced by radiation (regeneration of the image guide). In order to effectively restore the original light transmission of the defect-free or almost defect-free material, it is important that the heating of the optical fiber guides is as uniform as possible over the entire length of the fibers. At the same time, material stress caused by temperature gradients is avoided, which could cause the optical fiber guides to become brittle and break, resulting in irreversible loss of pixels in the image transmission.

Due to these requirements, the heating of the optical fiber guides has so far been carried out in a vacuum oven, configured to heat the optical fiber guides as evenly as possible. The problem with this is that the entire image guide has to be removed from its actual place of use, typically in an ultra-high vacuum, which may only be flooded (e.g., ventilated) with great effort, and installed in the vacuum oven. As flooding of the system in which the image guide is installed is necessary for disassembling, the image guide may only rarely be regenerated. Depending on where the image guide is used, the mounting may require considerable effort or may even be impossible for human operators due to residual radiation, for example, from activated metallic materials.

The object of the invention is to provide an improved image guide device, an improved method for manufacturing the image guide device, and an improved method for regenerating the image guide device, with which disadvantages of conventional techniques are avoided. In particular, the image guide device should permit regeneration with reduced effort, shortened regeneration intervals, greater speed, and/or lower costs.

This objective is solved by the subject matters of the independent claims. Advantageous further embodiments are given in the dependent claims and the description.

According to a first general aspect of the invention, the above objective is solved by an image guide device configured for image transmission to an image capture device. Preferably, the image guide device may be configured for image transmission from a reaction area to the image capture device. The reaction area may generally be an area, preferably an enclosed area, in which ionizing radiation occurs. Alternatively or additionally, ionizing radiation may occur along the length of the optical fiber bundle. The image guide device comprises a fiber optic bundle (fiber optics) configured for image transmission and connected to two connectors, each arranged at one end of the optical fiber bundle, and a guide sheath surrounding the fiber optic bundle and extending between the connectors. For fastening on the one hand to or in the reaction area and on the other hand to the image capture device, at least one of the connectors may be equipped with a coupling member, such as at least one flange and/or at least one insulating element. Furthermore, the image guide device comprises a heating conductor device comprising at least one heating conductor (sheath heating conductor), which is provided for heating the fiber optic bundle along its length, preferably continuously along its entire length, to a predetermined treatment temperature so that, by heating to the treatment temperature, radiation-induced material defects in the fiber optic bundle can be reduced.

Image transmission from a reaction area to a capture device means that an image of a scene in the reaction area is transmitted to a capture device that is arranged outside the reaction area and, in particular, is not in direct contact with the reaction area. Therefore, the fiber optic bundle may be connected on one side to an objective device (optics) in the reaction area and on the other side to the image capture device, such as a camera or an image sensor, by means of the connectors. The individual fibers of the fiber optic bundle are connected to the connectors at their ends in a strictly ordered manner so that the relative orientation of the fibers, i.e., the pixels in the transmitted image, does not change. Pixels that are arranged next to each other on the objective device are also arranged next to each other on the image capture device.

The reaction area is preferably an, for example, enclosed chamber inside which images are to be captured. This may be, for example, the plasma combustion chamber of a fusion generator or a particle accelerator or an operating room of such facilities. These examples of reaction areas have in common that they sometimes generate considerable amounts of ionizing radiation in their environment during operation, which could damage or even destroy the image capture device. Due to image transmission from the reaction area, the image capture device does not need to be arranged in or in the immediate vicinity of the reaction area and may, for example, be surrounded by a protective housing.

The fiber optic bundle is surrounded in the guide sheath, which may consist of a flexible hose or a rigid, preferably deformable, tube, for example. The fibers of the fiber optic bundle are thus protected from external influences, such as dirt or mechanical loads. In addition, a fastening device may be attached to the guide sheath for fastening the image guide device at the place of use without stressing the fibers of the fiber optic bundle. Ionizing radiation in the environment of the reaction area may, however, penetrate the guide sheath as far as the fiber optic bundle so that material defects occur in the lattice structure of the fiber optic bundle, which leads to a deterioration in light transmission. These material defects are reversed by heating the fiber optic bundle.

The fiber optic bundle comprises a large number of fiber optics, whereby, depending on the configuration, several fiber optics lying next to each other may also be combined to form fiber strands. The starting points of the individual fibers or fiber strands at one end of the fiber optic bundle are assigned to the end points of the respective fibers or fiber strands at the other end of the fiber optic bundle. In this way, the relative orientation of the pixels is maintained during image transmission. A fiber optic bundle may consist of, for example, at least 10, at least 100, or at least 1000 and up to several million individual fibers or fiber strands. The typical thickness of the fibers is in a range between 30 μm and 100 μm.

The at least one heating conductor extends along the length of the fiber optic bundle and advantageously allows for uniform heating of the fiber optic bundle. The heating conductor device therefore advantageously fulfills the function of the uniformly heating vacuum oven used in the prior art for regenerating the fiber optic bundle. As a result, the regeneration of the fiber optic bundle may be carried out directly at the point of use of the image guide device. There is no need for a difficult and time-consuming mounting in the vacuum oven. The heating conductor preferably comprises a resistance heating conductor that may be coupled to a power supply. Preferably, the power supply is configured to be controllable. In this way, the reliability of setting the temperature of the heating conductor device may be improved.

The at least one heating conductor preferably comprises a current-conducting core, which is sheathed by an electrically insulating material. The current-conducting core, which is made of constantan, for example, produces heat through its intrinsic electrical resistance, while the insulating sheath ensures that a current flow from the heating conductor to electrically conductive materials in the environment is prevented. A metal cladding may be provided on the outside of the electrically insulating material as an outer protective sheath for the heating conductor. Alternatively, the heating conductor may comprise the current-conducting core without the insulation provided by the electrically insulating material if the heating conductor is arranged in the image guide device in an electrically insulated manner by other measures.

A further particular advantage of the image guide device is that the regeneration of the fiber optic bundle may be carried out more frequently over shorter time intervals than is the case with the conventional technique, without substantially impairing the use of the image guide device. If the conventional method of regeneration is used, in which the image guide has to be removed from its place of use and installed in an oven, it is hardly possible in practice to do anything other than leave the image guide in its place of use for as long as it may be used sensibly. Mounting into the oven only takes place when the transmission of the image guide has already been reduced to such an extent that further use is no longer acceptable, or when a generally longer maintenance phase of the reaction area is due. However, C. P. Chrobak et al. showed in “Rev. Sci. Instrum.” 83, 10E514(2012) that it is advantageous to heat fiber optic bundles more frequently and for shorter periods of time, as in this way the occurrence of irreversible radiation damage in the fiber optic bundle may be avoided. This advantage can be better utilized with the image guide device according to the invention.

According to a second general aspect of the invention, the above objective is solved by a method for manufacturing the image guide device according to the first general aspect or one of its embodiments. In the method according to the invention, first the fiber optic bundle and the guide sheath for accommodating the fiber optic bundle are provided. Subsequently, the fiber optic bundle is positioned within the guide sheath, and the two connectors are provided for connection to the fiber optic bundle. Then, the at least one heating conductor is positioned along the length of the guide sheath. Finally, each of the connectors is connected to one of the two ends of the fiber optic bundle and the corresponding end of the guide sheath.

An important advantage of the method according to the invention is that it allows the heating conductor to be aligned along the fiber optic bundle such that a particularly uniform heat distribution along the fiber optic bundle may be achieved by the heating conductor. By positioning the fiber optic bundle inside the guide sheath before positioning the heating conductor, it can be ensured that the heating conductor does not damage the fibers of the fiber optic bundle.

According to a third general aspect of the invention, the above objective is solved by a method for regenerating the image guide device according to the first general aspect or one of its embodiments, in which the fiber optic bundle is heated to the treatment temperature via the heating conductor device so that, by heating to the treatment temperature, radiation-induced material defects in the fiber optic bundle are reduced. Preferably, the heating to the treatment temperature occurs in the range of 100 °C and 300 °C, in particular 200 °C and 250 °C. Alternatively, a higher treatment temperature may be set, with the maximum treatment temperature being selected as a function of the heat compatibility of the components used, in particular the adhesive used to hold the fibers together. In particular, the treatment temperature may be selected such that outgassing from components of the image guide device, in particular the adhesive, is excluded or reduced to a negligible level at the treatment temperature.

Advantageously, the regeneration method according to the invention allows radiation-induced defects in the lattice structure of the fiber optic bundle to be reduced or even completely reversed. The temperature range selected in practice for regenerating the fiber optic bundle depends in particular on the material composition of the fiber optic. In addition, the temperature range may be selected depending on the type of ionizing radiation that has created the defects in the lattice structure. For example, a Schott IG-163 fiber optic bundle that has been exposed to high-energy neutrons and gamma radiation from nuclear decay may be regenerated at a temperature of 200 °C. Which temperature may be used may, for example, be determined by simple tests or reference values from the technical literature.

According to a preferred embodiment of the invention, the at least one heating conductor extends along the outside of the guide sheath and is in thermal contact with the guide sheath, wherein the at least one heating conductor extends along the length of the guide sheath, in particular along the entire length of the guide sheath. In this way, the heating conductor itself does not come into contact with the fiber optic bundle.

Mechanical damage to the individual fibers by the heating conductor may be advantageously excluded. Instead, the heating conductor transfers heat to the guide sheath, inside which the fiber optic bundle is located. The heating conductor preferably extends continuously over the entire length of the guide sheath. This improves the uniformity of heat distribution inside the guide sheath. The fiber optic bundle is over its entire length in an environment with uniform temperature so that there is no temperature gradient along the length of the fiber optic bundle. It also prevents individual fibers from overheating and being damaged by direct contact with the heating conductor.

According to an alternative preferred embodiment of the invention, the at least one heating conductor is arranged together with the fiber optic bundle in the interior of the guide sheath and extends along the length of the guide sheath, particularly preferred along the entire length of the guide sheath. The advantage of this embodiment is that the heat of the heating conductor may be transferred directly to the fiber optic bundle and without delay through the additional mass of the guide sheath. This embodiment is therefore particularly suitable for applications in which the temperature and, in particular, the temperature profile of the fiber optic bundle over time needs to be controlled very precisely. This may be advantageous, for example, in the development and testing of materials for fiber optics. In addition, the influence of the guide sheath on the heat distribution inside the guide sheath may be reduced. The material and the geometric shape of the guide sheath only have a minor influence on the heat distribution inside, so the shape of the guide sheath may be better adapted to the external conditions.

In this embodiment, care is preferably taken, particularly when assembling the heating conductor device, to ensure that the fibers of the fiber optic bundle are not damaged and that the heating conductor is not pressed excessively against the fibers when the guide sheath with the fiber optic bundle and the guide sheath is moved or bent.

According to a further alternative embodiment of the invention, the at least one heating conductor may be embedded in the guide sheath and extend along the length of the guide sheath, in particular along the entire length of the guide sheath. This variant of the invention may have advantages with respect to the positioning and the electrical insulation of the at least one heating conductor.

In a further preferred embodiment, the heating conductor device comprises several heating conductors, in particular two heating conductors, which extend along the length of the guide sheath, in particular along the entire length of the guide sheath. Particularly preferred, the heating conductors are arranged on different, in particular opposite, sides of the fiber optic bundle. For example, the heating conductors may be arranged opposite to each other. Already one heating conductor, which preferably extends along the entire length of the guide sheath, ensures a uniform temperature of the fiber optic bundle in the longitudinal direction and also in the circumferential direction of the fiber optic bundle.

Providing two heating conductors in this embodiment may help to further improve the uniformity of heat distribution in the circumferential direction of the fiber optic bundle and/or increase reliability, e.g., due to a mechanical defect.

Advantageously, the two heating conductors may be arranged electrically connected in series and may be coupled to a power supply via two heating conductor connectors at a common end of the optical fiber bundle, preferably the end facing the image capture device. In other words, the two heating conductors may be arranged electrically connected in series, wherein a first heating conductor extends from a first heating conductor connector at a first end of the fiber optic bundle to the second end of the fiber optic bundle and is connected at the second end of the fiber optic bundle directly or via a further heating conductor to the second heating conductor extending from the second end of the fiber optic bundle to a second heating conductor connector at the first end of the optical fiber bundle, wherein the heating conductor connectors may be coupled to a common power supply. This embodiment of the invention has the advantage that the heating conductor connectors are arranged together at the same end of the fiber optic bundle. Therefore, coupling to the power supply is only necessary at one end of the fiber optic bundle. Furthermore, especially when using heating conductors that are not separately electrically insulated, additional mutual electrical insulation of the heating conductors may be omitted due to the separate arrangement of the heating conductors on different sides of the fiber optic bundle. As an alternative to the series connection mentioned above, the two heating conductors may be connected electrically in parallel and coupled to a power supply via two heating conductor connectors.

In embodiments with several heating conductors, an even number of heating conductors may preferably be provided, with two of the heating conductors being electrically connected in series in each case and equipped with the heating conductor connectors at the same end of the fiber optic bundle and, in particular, all of the heating conductor connectors being arranged at the same end of the fiber optic bundle.

Preferably, the heating conductor device comprises an additional heating conductor (connector heating conductor) on at least one of the connectors, which at least partially surrounds the connector and is in thermal contact with the connector. In this way, in addition to the guide sheath, the connector is also brought to a uniform temperature, preferably to the same temperature as the guide sheath. The individual heating conductors of the heating conductor device may be operated separately from each other (adjustable and/or controllable) and/or may each be coupled to a separately assigned power supply. Additionally or alternatively, several heating conductors may be combined into groups that may be controlled together and/or operated via a common power supply. Temperature gradients of the fiber optic bundle in the portion of the connector may thus be avoided, whereby the most efficient recovery of the transmission properties of the fiber optic bundle may be achieved. In addition, temperature-induced material stress in the fiber optic material and, in particular, in the portion of the connectors, embrittlement of the fiber optic bundle, possibly with breakage of individual fibers, may be avoided.

If the two heating conductors are arranged electrically connected in series and the additional heating conductor is provided, according to a further advantageous embodiment of the invention, the two heating conductors may be electrically connected in series via the additional heating conductor. In this case, a first heating conductor extends from the first heating conductor connector to the second end of the fiber optic bundle, where the first heating conductor is connected in series with the additional heating conductor, and the latter is connected in series with the second heating conductor extending from the second end of the fiber optic bundle to the second heating conductor connector.

Alternatively, especially if the two heating conductors are arranged electrically connected in series and the additional heating conductor is provided, the two heating conductors may be electrically connected directly to each other in series and may be coupled to a power supply, and the additional heating conductor may be coupled to a further power supply. In this case, the temperatures at the respective image guide ends and along the fiber optic bundle may be set independently. Advantageously, a uniform temperature may thus be set everywhere along the entire length of the fiber optic bundle, and uneven heating may be avoided, which may lead, for example, to the loosening or burning of an adhesive or a locally insufficient bake-out temperature (undertemperature).

According to an advantageous embodiment, a method for manufacturing an image guide device further comprises the step of positioning at least one additional heating conductor such that it at least partially surrounds at least one of the connectors and is in thermal contact with the connector. For this purpose, the heating conductor may be shaped to fit the connector before positioning, e.g., by bending the heating conductor around a mandrel that is adapted to the shape of the connector. Preferably, a heating conductor material with elasticity is used. In order to bend the heating conductor into a shape that corresponds to the contour of the connector, the mandrel used will usually comprise a slightly different shape than the connectors, so that when the heating conductor is removed from the mandrel, the somewhat elastic heating conductor springs into the correct shape.

The guide sheath particularly preferred comprises a thermal conductivity of a metallic material. The thermal conductivity of metals is typically greater than 15 W/(m·K), for certain materials, it is also several 100 W/(m·K). The thermal conductivity of most non-metals is significantly lower. Due to the high thermal conductivity of the material of the guide sheath, the heat of the heating conductor may be transferred to the fiber optic bundle with little delay. In addition, the guide sheath itself is quickly brought to a uniform temperature so that temperature gradients inside the guide sheath can be avoided.

According to a further embodiment, the image guide device further comprises at least one jacket hose, uniformly covering the guide sheath and the at least one heating conductor laterally, in particular completely surrounding them, and is configured to distribute heat from the at least one heating conductor to the guide sheath. Preferably, the at least one jacket hose comprises a thermal conductivity of a metallic material and/or is elastic. The at least one jacket hose surrounds the guide sheath and contributes to a further improvement in uniform heat distribution. The at least one jacket hose may be pulled partially or completely over the connectors so that a possible uneven temperature gradient may be prevented, particularly at the transition points to the connectors.

A single jacket hose may be provided, which makes the structure of this embodiment of the image guide device relatively simple. Alternatively, several jacket hoses, e.g., flexible hoses made of wire mesh, in particular copper, may be provided, which are arranged one above the other in the radial direction. Several jacket hoses may be arranged directly adjacent to each other on top of each other, or they may be separated from each other by intermediate layers. The jacket hose, or one of the several jacket hoses, may be arranged between the at least one heating conductor and the guide sheath, which advantageously increases the heat conducting surface to the guide sheath.

If the heating conductor is arranged along the length of the fiber optic bundle on the outside of the guide sheath, the jacket hose may press the heating conductor against the guide sheath and thus improve the constant thermal contact between the heating conductor and the guide sheath. For this purpose, it is particularly advantageous if the jacket hose is made of an elastic material. If the jacket hose is also made of a material with the thermal conductivity of a metal, the jacket hose may help to transfer the heat from the heating conductor to the guide sheath as evenly as possible. The jacket hose preferably comprises a metal braid, for example, a hose made from a copper braid.

In a further embodiment of the invention regarding the method, the following steps are provided: providing a jacket hose comprising a thermal conductivity of a metallic material and being elastic and covering the guide sheath, the fiber optic bundle, and the at least one heating conductor, which is provided for heating the fiber optic bundle, with the jacket hose such that the jacket hose uniformly covers, in particular completely surrounds, the at least one heating conductor for a distribution of heat from the at least one heating conductor to the guide sheath.

In a particularly preferred variant, in which the method comprises covering the guide sheath, the fiber optic bundle, and the at least one heating conductor with the jacket hose, the method may further comprise the step of mounting the jacket hose on an auxiliary tube having an inner diameter larger than the outer diameter of the assembly of the guide sheath, the fiber optic bundle, and the at least one heating conductor. The jacket hose with the fiber optic bundle and the at least one heating conductor may then be positioned in the auxiliary tube. Finally, the auxiliary tube is retracted from the guide sheath with the fiber optic bundle and the at least one heating conductor, while the jacket hose remains on the guide sheath, the fiber optic bundle, and the at least one heating conductor.

Advantageously, these additional process steps simplify the correct positioning of the jacket hose on the heating conductor and the guide sheath and ensure that none of the components of the image guide device are displaced undesirably by the attachment of the jacket hose. It is also easier to cover a smooth auxiliary tube with the jacket hose than the uneven guide sheath with the connectors and the heating conductor. The jacket hose could get caught, in particular, on the edges of the connectors and possibly even be damaged, which could reduce the heat compensation provided by the jacket hose.

As the jacket hose is preferably elastic, it may be pulled over an auxiliary tube whose outer diameter is larger than the outer diameter of the guide sheath with the heating conductor and the connectors. The jacket hose could, for example, be a hose made of a copper braid, the diameter of which may be increased by compressing the hose. When the hose is compressed, it is pushed together longitudinally. The orientation of the copper fibers is rotated slightly so that the length of the jacket hose is shortened but the diameter is increased.

The remaining components of the image guide device may then be pushed into the tube without obstruction and positioned in such a way that one end of the jacket hose is located approximately where it should remain in its final state. This end is held in place, and the auxiliary tube is pulled off. This end of the jacket hose remains in the specified position on the guide sheath or the connector. The remaining jacket hose is laid evenly over the guide sheath with the heating conductor device and the fiber optic bundle without getting caught on any edges and being damaged in the process.

According to a further preferred embodiment, the image guide device further comprises at least one temperature sensor configured for detecting the temperature of the image guide device. In particular, the temperature sensor may be configured for detecting the temperature of the guide sheath. The detected temperature may be used to set the heating conductor device to the desired temperature by means of a control system. This may be done manually by a human user or automatically by a control system.

For example, the power supply of the heating conductors may include a control unit configured to receive temperature data from the temperature sensor and control the temperature of the heating conductor using a proportional-integral-differential (PID) loop. Alternatively, the closed-loop or open-loop control may also be carried out by a software module.

Preferably, the heating conductor device is configured to heat the fiber optic bundle to the treatment temperature in the range of 100 °C and 300 °C, in particular 200 °C and 250 °C, which correspond to the regeneration temperatures of typical fiber optic bundles.

According to one embodiment, the method for manufacturing the image guide device may further comprise the step of attaching at least one temperature sensor configured for detecting the temperature of the image guide device. In variants in which the image guide device comprises a jacket hose, a temperature sensor may preferably be positioned between the guide sheath and the jacket hose.

In a further embodiment, the image guide device further comprises a supplementary heating device comprising a temperable working gas configured for heating at least one peripheral component of the image guide device. This embodiment is preferably provided when the image guide device is operated in ambient pressure, i.e., not in a vacuum. For example, the supplementary heating device may be used to bring the working gas, for example nitrogen, to a temperature that is close to the temperature of the guide sheath. This gas may be used to heat components and parts in the vicinity of the image guide device, especially if these components are in interaction with the image guide device.

For example, the working gas may be used to heat the optics to which the image guide device is connected on the reaction area side. In many cases, the fiber optic bundle is joined to the connectors by means of adhesive bonding. When the image guide device is heated, these adhesive connections may outgas under certain circumstances. These gases could condense on the optics and cause soiling or clouding of the optics. Heating the optics to a temperature close to the image guide temperature may prevent or at least reduce this condensation. Alternatively or additionally, the flowing working gas may be used to keep unwanted adhesive vapors away from light-transmitting surfaces in the beam path, in particular from the input/output window of the fiber optic bundle and/or the optics. The heated working gas may absorb the gases from the adhesive bond and be extracted by a pumping device.

According to one embodiment of the invention, the method for regenerating the image guide device may further comprise the steps of heating the working gas with the supplementary heating device to a temperature in the range of 100 °C and 400 °C, in particular 200 °C and 300 °C, and tempering, in particular supplying the heated working gas, to at least one peripheral component of the image guide device.

In a further embodiment, the image guide device may be equipped with at least one transparent plate, preferably made of glass, in particular quartz glass, arranged, on the reaction area side, adjacent to the input/output window of the fiber optic bundle and/or the optics such that the input/output window and/or the optics are protected from fogging during bake-out. Alternatively or additionally, at least one transparent plate, preferably made of glass, in particular quartz glass, may be arranged on the image capture device side, adjacent to the input/output window of the fiber optic bundle, such that the image capture device is protected from fogging during bake-out. A further advantage of the transparent plate(s) is that by observing the plate surface, e.g., by means of an optical measurement, the degree of soiling may be detected directly during bake-out.

The at least one transparent plate may be arranged in a fixed position in the beam path.

Alternatively, the at least one transparent plate may preferably be arranged to be movable and may be adjusted with at least one drive between a position outside the beam path of the image transmission and a position in the beam path (e.g., transparent glass shutter). Even if the drive fails, it is advantageously still possible to transmit images through the plate.

According to further variants of the invention, the at least one transparent plate may be equipped with a plate heating device, e.g., a resistance heater, and may be heatable and/or comprise a thermally conductive coupling with the respective heated end of the image guide device, in particular of the fiber optic bundle. The thermally conductive coupling may, for example, comprise a metallic bridge between an optionally provided metallic frame of the at least one transparent plate and the respective heated end of the image guide device. Advantageously, the at least one transparent plate may thus be baked out and cleaned of interfering deposits, for example, during regeneration of the image guide device.

According to a further preferred embodiment, the method may further comprise the step of attaching at least one retaining clip to the image guide device, wherein the at least one retaining clip is made of an electrically and thermally insulating material at its contact points with the image guide device. In a further step, the at least one retaining clip is attached to at least one peripheral component of the heating conductor device.

In this way, it can be ensured that the image guide device does not come into contact with peripheral components that are not configured for high temperatures. The use of thermally insulating material prevents heat from flowing from the heating conductor device to the environment via the retaining clips. On the one hand, the environment is protected from the high temperatures of the image guide device. On the other hand, this prevents a temperature gradient from occurring within the guide sheath due to heat dissipation at individual settings of the image guide device. Furthermore, unwanted or excessive bending of the guide sheath with the fiber optic bundle and the heating conductor device may advantageously be avoided by the retaining clips supporting the image guide device so that, for example, excessive sagging of the image guide device may be prevented.

The use of electrically insulating material may prevent damage to electrical components from being transferred to other components. This applies both to uncontrolled electrical currents flowing from the surroundings of the image guide device to the image guide device and to an uncontrolled current flowing to other components in the vicinity of the image guide device in the event of a short circuit due to an insulation fault in the heating conductor device.

Further details and advantages of the invention are described below with reference to the drawings. The drawings show:

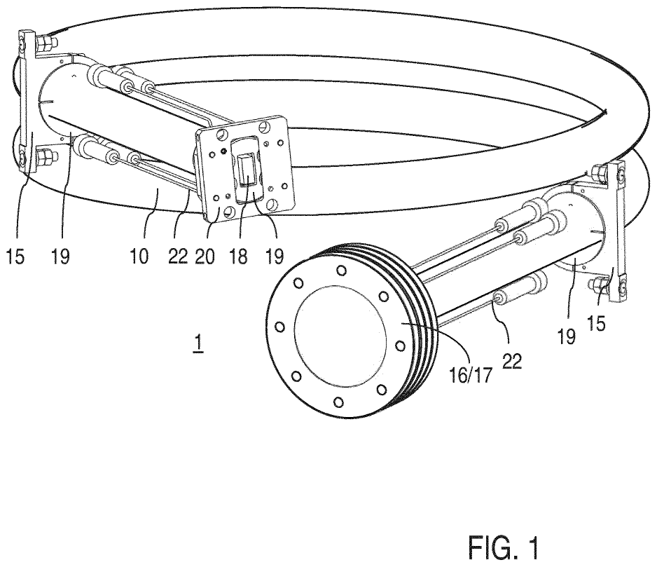

FIG. 1: a perspective view of a preferred embodiment of the image guide device according to the invention;

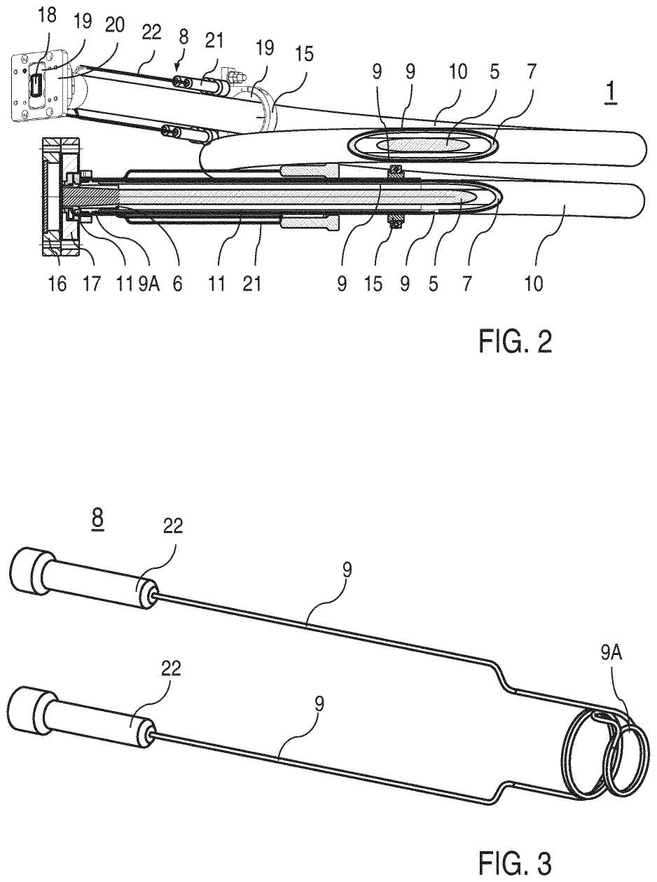

FIG. 2: a further, partially sectioned perspective view of the image guide device according to an advantageous embodiment of the invention;

FIG. 3: a perspective view of an additional heating conductor for attachment to one of the connectors according to advantageous embodiments of the invention; and

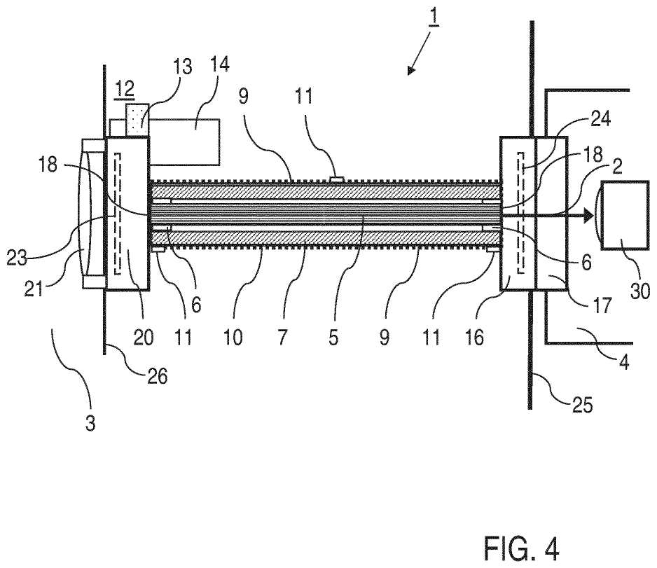

FIG. 4: sectional views of the image guide device at the place of use according to an advantageous embodiment of the invention.

Features of preferred embodiments of the image guide device according to the invention are described below with exemplary reference to embodiments that are equipped with a total of four heating conductors and in which the image guide device is at least partially covered with a jacket hose made of a copper braid. Furthermore, the exemplary image guide is configured for use in a vacuum environment and therefore comprises vacuum-compatible flange connections on both connectors. It is emphasized that the application of the invention is not limited to this example but may accordingly also be advantageous in other environments, in particular at atmospheric pressure, and in other configurations. For example, it is not necessary that the image guide device be configured to be vacuum compatible. Furthermore, the implementation of the invention in practice is not limited to the exemplary shapes and dimensions of the individual components. Rather, the image guide device may be modified depending on the specific application of the image guide device. An optical system for image capture on the side of the reaction area may be considered as part of the image guide device according to the invention or alternatively separately as part of the reaction area. Furthermore, a window flange on the side of the image capture device may be considered as part of the image guide device according to the invention or alternatively separately as part of the image capture device.

According to further variants, the image guide device may be connected to the connectors with other connecting elements, and/or the illustrated flange connections may be omitted, e.g., if the connectors are connected directly to their respective place of use. Furthermore, the image guide device may comprise a jacket hose made of a different material, or several jacket hoses may be provided, or a jacket hose may be omitted entirely. Furthermore, the heating conductor device may comprise more or less than four heating conductors. For example, an image guide device could comprise only a single sheath heating conductor or more than two. The heating conductors may also be directly connected to a power supply and/or operated with a temperature control. For this purpose, for example, temperature sensors and heating conductors could be installed in one unit.

The embodiments shown in the figures are at least partially identical, so that similar or identical parts are provided with the same reference signs, and reference is also made to the description of the other embodiments or figures in order to avoid repetitions. FIG. 1 shows a schematic perspective view of an embodiment of the image guide device 1 according to the invention. FIG. 2 shows a partially sectioned perspective view of an embodiment of the image guide device 1, which substantially corresponds to the embodiment of FIG. 1. FIG. 3 shows a detail of the arrangement of heating conductors. FIG. 4 shows a schematic sectional view of the image guide device 1 at the place of use.

The image guide device 1 comprises a guide sheath 7, inside which there is a fiber optic bundle 5. The guide sheath 7 and the fiber optic bundle 5 are each equipped with a connector 6 at both ends (see FIGS. 2, 4). Each connector 6, which is made of stainless steel, for example, couples the ends of the fiber optic bundle 5 to the ends of the guide sheath 7. The individual fibers of the fiber optic bundle 5 are firmly enclosed in the connectors 6 in such a sorted manner that input/output windows 18 are formed, and during image transmission 2 (shown schematically in FIG. 4), the image received in a reaction area 3 is transmitted to the side of the image capture device 4 as a camera 30. For this purpose, the individual fibers of the fiber optic bundle 5 are usually inserted into a grid-like holding structure of the respective connector 6 using an adhesive connection. The grid of the holding structure may correspond to the pixels of the image capture device 4.

The outer diameter of the fiber optic bundle 5 is preferably smaller than the inner diameter of the guide sheath 7, so that the fiber optic bundle 5 is arranged inside the guide sheath 7 with a clearance in the radial direction. Advantageously, this minimizes mechanical damage to the fiber optic bundle 5. Although in practice the fiber optic bundle 5 typically rests on an inner wall in the guide sheath 7 under the effect of gravity, uniform heating of the fiber optic bundle 5 is achieved with the heating conductor device. Alternatively, the outer diameter of the fiber optic bundle 5 may be adapted to the inner diameter of the guide sheath 7 so that the guide sheath 7 touches the fiber optic bundle 5 on all sides. This variant of the invention may have the advantage of improving the heat transport from the heating conductor device to the fiber optic bundle 5.

The fiber optic bundle 5 comprises, for example, a fiber strand with 1 190 000 fibers, the fibers having a diameter of 10 μm and being made of quartz glass. The total length of the fiber optic bundle 5 is, e.g., 2 m, and the fiber optic bundle 5 has a cross-sectional dimension at its ends, e.g., a diameter or side length of the input/output window 18 of the fiber optic bundle 5, of, e.g., 7 mm*17 mm. The individual fibers are connected to the connectors 6 by means of an adhesive. The guide sheath 7 is a flexible tube, e.g., a spiral tube made of stainless steel with a wall thickness of the tube material of a few tenths of a millimeter, an outer diameter of 29 mm, and an inner diameter of 25 mm.

The guide sheath 7 is covered with a jacket hose 10 (shown dotted in FIG. 4). The jacket hose 10 is preferably made of an elastic material comprising the thermal conductivity of a metal, such as a wire mesh (not shown in detail), e.g., copper mesh (manufacturer, e.g., Techflex Germany GmbH). The jacket hose 10 advantageously improves the uniformity of heat distribution inside the guide sheath 7, which improves the efficient regeneration of the fiber optic bundle 5.

The heating conductor device 8 according to the invention comprises two heating conductors 9 (sheath heating conductors), which are arranged on the outside of the guide sheath 7 between the jacket hose 10 and the guide sheath 7 (see FIGS. 2, 4). The heating conductors 9 are located on opposite sides of the guide sheath 7, e.g., in FIG. 2 on an upper side and a lower side, and they may be coupled to associated power supplies (not shown) via heating conductor connectors 22. The two heating conductors 9 each extend over the entire length of the guide sheath 7. Furthermore, several temperature sensors 11 are arranged on the outside of the guide sheath 7 (see FIGS. 2, 4).

As an alternative to the embodiment shown, at least one heating conductor 9, which extends along the length of the guide sheath 7, may be arranged inside the guide sheath 7 between the fiber optic bundle 5 and the guide sheath 7. In this case, the heat of the heating conductor 9 may be emitted directly inside the guide sheath 9, whereby the material of the guide sheath 7 has less influence on the heat distribution.

In addition to the two heating conductors 9, which extend along the guide sheath 7, the heating conductor device 8 comprises an additional heating conductor 9A (connector heating conductor, see FIGS. 2, 3) on each of the connectors 6. The additional heating conductors 9A surround the two connectors 6 at least partially. The additional heating conductors 9A may be coupled to associated power supplies (not shown) via heating conductor connectors 22. The additional heating conductors 9A, which are preferably adapted to the contour of the connectors 6, may advantageously avoid an undesirable temperature gradient in the portion of the connectors 6 and improve the regeneration capability and mechanical resistance of the fiber optics.

The heating conductors 9, 9A are formed as resistance heating elements (manufacturer, e.g., ThermoExpert Deutschland GmbH) and may each be connected to a power supply, e.g., a power supply unit (not shown). Accordingly, the illustrated embodiment with four heating conductors 9 comprises eight heating conductor connectors 22. Alternatively, the heating conductors 9, 9A may be partially combined into groups. For example, the two heating conductors 9 that extend along the guide sheath 7 could be combined into a group and operated together with a single power supply (see FIG. 3). The two heating conductors 9A on the connectors 6 (see, e.g., FIGS. 2 and 4) may each be operated with one or two separate power supplies. Alternatively, a common power supply with several outputs may be provided for all heating conductors 9, 9A, each of which may be controlled separately.

As illustrated by the heating conductor device 8 shown alone in FIG. 3, two heating conductors 9 may be arranged electrically connected in series and may be coupled to a power supply (not shown) via two heating conductor connectors 22 at a common end of the fiber optic bundle. The heating conductor 9 is connected in series at the opposite end via the additional heating conductor 9A.

The heating conductors 9, 9A each comprise an electrical insulation, preferably made of a mineral insulation material, such as MgO. The heating conductors 9, 9A are held in position on the surface of the guide sheath 7 by the jacket hose 10. In order to form a close thermal contact with the guide sheath 7, the heating conductors 9, 9A may also be fixed to the guide sheath 7 or the connectors 6 with fastening elements, e.g. silver wire.

At the ends of the guide sheath 7, the image guide device 1 preferably comprises coupling means to which the connectors 6 are connected (see FIGS. 1, 2, and 4). The end of the guide sheath 7 on the side facing a schematically shown camera 30 of the image capture device 4 comprises several coupling means, which comprise a connector flange 17, e.g., a CF flange, and a window flange 16 of the camera 30 and are detachably connected to each other, e.g., screwed together. At the other end, a coupling means on the connector 6 is an optics flange 20, which is configured for connection to an optics 21 (see FIG. 4) in the reaction area 3.

In order to prevent heat from flowing from the image guide device 1 to the reaction area 3 or the image capture device 4, at least one of the coupling means may comprise an insulating element 19 made of heat-insulating material, e.g., a plastic plate with a continuous opening, at the respective end of the associated connector 6. Preferably, the material of the at least one insulating element 19 is also electrically insulating so that any uncontrolled current flow in the vicinity of the image guide device 1 does not reach the connectors 6. Furthermore, in the event of a malfunction of a component of the image guide device 1, e.g., in the event of a short circuit due to an insulation fault in the heating conductors 9, further peripheral components 14 are prevented from being damaged, or that bake out the reaction area 3, for example, a vacuum chamber, at high temperatures could result in damage to the fiber optics.

FIG. 4 shows a schematic sectional view of the image guide device 1 at the place of use. For reasons of clarity, FIG. 4 is not to scale. On the left-hand side is the reaction area 3, from which images are to be captured and transmitted to the image capture device 4 on the right-hand side. Reaction area 3 is, for example, the combustion chamber of a fusion reactor. The reaction area 3 and preferably the entire image guide device 1 are located in a portion in which an ultra-high vacuum is formed. The ultra-high vacuum portion is delimited from the environment at a higher pressure, e.g., atmospheric pressure, for example, by a schematic, partially shown reactor wall device 25. The image guide device 1 may be used to capture images of a fusion plasma in the combustion chamber of the fusion reactor and forward them to the image capture device 4 arranged in the higher pressure environment. Other possible applications include monitoring the beam properties of a particle accelerator or capture images from environments with unfiltered cosmic radiation (space telescopes, space stations, lunar vehicles, etc.).

The fiber optic bundle 5 is connected to a window flange 16 of the image capture device e 4 via the connector 6 and the connecting flange 17. The connector flange 17 is provided for a pressure-tight connection to the reactor wall device 25. The window flange 16 and the image capture device 4 are located in the atmospheric pressure environment. On the left side, the fiber optic bundle 5 is connected via the further connector 6 to the optics flange 20, which in turn is connected to the optics 21 in the reaction area 3. The optics flange 20 is positioned in the ultra-high vacuum portion with a schematically shown holder 26. The input/output windows 18 of the fiber optic bundle 5 are exposed towards the reaction area 3 and the image capture device 4, so that on the one hand an image may be coupled into the fiber optic bundle 5 via the input/output window 18 on the side of the reaction area 3 using the optics 21 and on the other hand may be decoupled via the input/output window 18 on the side of the image capture device 4 and received by the image capture device 4. In this way, the image 2 is transmitted from the reaction area 3 to the distant image capture device 4. The fiber optic bundle 5 is inserted into the two connectors 6 on both sides by means of an adhesive connection.

FIG. 4 schematically illustrates optionally provided transparent plates 23, 24 (shown dashed), at least one of which is arranged between the input/output window 18 facing the reaction area 3 and the optics 21 and/or between the input/output window 18 facing the image capture device 4 and the image capture device 4. Preferably, the plate 23 is integrated into the optics flange 20 and/or the plate 24 is integrated into the window flange 16 and/or the connecting flange 17. The transparent plates 23, 24 are flat plates made of quartz glass. The plates 23, 24 are used to protect the optics 21 or the image capture device 4 from fogging when the fiber optic bundle 5 is heated. The plates 23, 24 are optionally each movable with a drive (not shown) in order to move them in the manner of a shutter into or out of the beam path of the optics 21 and/or the image capture device 4. The drives may also be integrated into the optics flange 20 and/or the window and/or connecting flange 16, 17.

Since the guide sheath 7 may be deformed with the fiber optic bundle 5, retaining clips 15, e.g., made of stainless steel, may be provided in the portion of the guide sheath 7 on the image guide device 1 in addition to the coupling means (see FIGS. 1, 2) to fix the image guide device 1. The retaining clips 15 are each separated from the guide sheath 7 by an insulating ring 19. The retaining clips 15 may be attached in the vicinity of the image guide device 1. In this way, the guide sheath 7 may be prevented from coming into contact with peripheral components 14 (schematically comprised in FIG. 4), which are not designed for a high thermal load.

Furthermore, the retaining clips 15 support the guide sheath 7 and the heating conductors 9 attached thereto as well as the fiber optic bundle 5. Advantageously, this prevents undesired deformation, such as sagging, of the image guide device 1 and its unintentional damage. FIGS. 1 and 2 show two retaining clips 15 in the vicinity of the connectors 6. In practice, more retaining clips 15 and/or retaining clips 15 at other positions may be used. Furthermore, the retaining clips 15 may comprise a different geometric shape, such as the shape of an elastic gripper.

Optionally, the image guide device 1 may comprise a supplementary heating device 12 that may heat a working gas 13 to a temperature range of 100 °C to 400 °C (see FIG. 4). This heated working gas 13 may be used to heat peripheral components 14 that interact with the image guide device 1 and/or components of the image guide device 1 to an intended temperature. For example, the adhesive material of an adhesive connection between the fiber optic bundle 5 and the connectors 6 could gas out. These gases may be deposited on the peripheral components 14, for example, on the optical flange 20 in the reaction area 3. The optical flange 20 could become contaminated and may have to be replaced. Depending on the type of reaction area 3, such as a particle accelerator, this may mean a considerable amount of work. Heating the peripheral components to a temperature that substantially corresponds to the temperature of the guide sheath 7 may prevent these gases from condensing on the peripheral component 14. The working gas, e.g., nitrogen or argon, may absorb the unwanted gases. As shown, the supplementary heating device 12 may be operated in the ultra-high vacuum portion, with a preferably locally acting feed pump (not shown) optionally being provided for a removal of the working gas with the escaped gas. The supplementary heating device 12 and optionally the feed pump may also be provided in applications of the invention with operation of the image guide device 1 under atmospheric pressure.

The image guide device 1 is manufactured by first providing the fiber optic bundle 5, the guide sheath 7, and the connectors 6 as separate components and positioning the fiber optic bundle 5 within the guide sheath 7. The fiber optic bundle 5 and the guide sheath 7 are connected to each other by fixing the connectors 6. The at least one heating conductor 9 is fixed along the length of the guide sheath 7 with fastening elements. The jacket hose 10 is then pulled over the guide sheath 7 with the at least one heating conductor 9.

In order to cover the guide sheath 7 with the jacket hose 10, an auxiliary tube (not shown) may be used, which comprises a larger diameter than the assembly of guide sheath 7, connectors 6 (possibly with a socket), heating conductor device 8, and fiber optic bundle 5. The jacket hose 10 is first pulled over the auxiliary tube. As the jacket hose 10 is made of an elastic material and the auxiliary tube comprises less unevenness than the guide sheath 7 with the components connected to it, the jacket hose 10 may be easily pulled over the auxiliary tube. The guide sheath 7 with the other components is then pushed through the auxiliary tube. One end of the jacket hose 10 is placed approximately in the position where it should be on the fully assembled image guide device 1. In the next step, this end of the jacket hose 10 and the guide sheath 7 with the other components are held in place, and the auxiliary tube is pulled off, leaving the jacket hose 10 on the guide sheath 7.

The connector heating conductors 9A are then attached to the connectors 6. The preparation of the connector heating conductor 9A is shown in FIG. 3. To adapt the shape of the connector heating conductor 9A to the shape of the connectors 6, the heating conductor 9A is bent over a suitably shaped mandrel. The resulting windings match the outer contour of the associated connectors 6. The shape of the mandrel takes into account the elasticity of the heating conductor 9A in such a way that the heating conductor 9A springs into the intended shape when it is removed from the mandrel.

The image guide device 1, which is preferably intended for use in radiation-exposed environments, is operated as follows. The interaction with ionizing radiation causes defects in the lattice structure of the fibers of the fiber optic bundle 5, which results in clouding and/or discoloration of the fibers that are transparent without irradiation. By heating the fibers to a few 100 °C, many of these defects may be healed. The image guide device 1 makes it possible to regenerate the fiber optic bundle 5 directly at the place of use without having to mounting the image guide device 1 into a special oven.

For this purpose, the heating conductor device 8 is connected to power supplies as required, i.e., when transmission is restricted and/or at predetermined maintenance intervals, in order to be heated to a temperature in the range of 100 °C and 300 °C, in particular 200 °C and 250 °C. The regeneration temperature is selected as a function of the glass type of the fiber optic bundle 5, the type of ionizing radiation that has produced the material defects, the possible outgassing behavior of any adhesive contained in the image guide device 1 and the temperature at which the irradiation took place. During image transfer 2 between the reaction area 3 and the image capture device 4, the image guide device 1 is operated at a temperature below 100 °C, typically at room temperature.

By applying an electric current, the heating conductors 9, 9A heat up to the desired temperature. For this purpose, the temperature of the guide sheath 7 and/or of at least one of the connectors 6 is preferably measured using the temperature sensors 11. The temperature sensors 11 are part of a control loop, e.g., a proportional-integral-differential loop, which is connected to the power supplies. The temperature data from the temperature sensors 11 are used in the control loop as actual values of the controlled variable for regulating the power supply. Heating ends after sufficient transmission has been achieved by the image guide device 1 and/or after a predetermined time interval. The image guide device 1 may then be disconnected from the power supply and used for image transmission.

Practical tests of the image guide device 1 by the inventors have shown that a radiation-induced reduction and spectral shift in the transmission of the fiber optic bundle 5 could be reversed in a quantitatively similar way as by conventional baking in a vacuum oven.

The features of the invention disclosed in the above description, the drawings, and the claims may be of importance for the realization of the invention in its various embodiments, both individually and in combination or sub-combination.

### LIST OF REFERENCE SYMBOLS

1 image guide device
2 image transmission
3 reaction area
4 image capture device
5 fiber optic bundles
6 connector
7 guide sheath
8 heating conductor device
9 heating conductor
9A heating conductor
10 jacket hose
11 temperature sensor
12 supplementary heating device
13 working gas
14 peripheral component
15 retaining clip
16 window flange
17 connecting flange
18 input/output window
19 insulation ring
20 optics flange
21 optics
22 heating conductor connector
23 plate
24 plate
25 wall device
26 holder
30 camera.

1. An image guide device configured for image transmission to an image capture device, comprising:
a fiber optic bundle configured for image transmission and connected to two connectors, each arranged at one end of the fiber optic bundle, and
a guide sheath surrounding the fiber optic bundle and extending between the connectors, and
a heating conductor device comprising at least one heating conductor, which is provided for heating the fiber optic bundle along its length to a predetermined treatment temperature so that, by heating to the treatment temperature, radiation-induced material defects in the fiber optic bundle can be reduced.

2. The image guide device according to claim 1, wherein
the at least one heating conductor extends along an outside of the guide sheath and is in thermal contact with the guide sheath, wherein the at least one heating conductor extends along a length of the guide sheath.

3-23. (canceled)

24. The image guide device according to claim 2, wherein
the at least one heating conductor extends along an entire length of the guide sheath.

25. The image guide device according to claim 1, wherein
the at least one heating conductor is arranged together with the fiber optic bundle in an interior of the guide sheath and extends along a length of the guide sheath.

26. The image guide device according to claim 25, wherein
the at least one heating conductor extends along an entire length of the guide sheath.

27. The image guide device according to claim 1, wherein
the at least one heating conductor is embedded in the guide sheath and extends along a length of the guide sheath.

28. The image guide device according to claim 27, wherein
the at least one heating conductor extends along an entire length of the guide sheath.

29. The image guide device according to claim 1, wherein
the heating conductor device comprises two heating conductors, which extend along a length of the guide sheath.

30. The image guide device according to claim 29, wherein
the two heating conductors extend along an entire length of the guide sheath.

31. The image guide device according to claim 29, wherein
the two heating conductors are arranged on different sides of the fiber optic bundle.

32. The image guide device according to claim 31, wherein
the two heating conductors are arranged on opposite sides of the fiber optic bundle.

33. The image guide device according to claim 29, wherein
the two heating conductors are arranged electrically connected in series and can be coupled to a power supply via two heating conductor connectors at a common end of the fiber optic bundle.

34. The image guide device according to claim 1, wherein
the heating conductor device comprises, on at least one connector of the two connectors, an additional heating conductor, which at least partially surrounds the at least one connector and is in thermal contact with the at least one connector.

35. The image guide device according to claim 34, wherein
the additional heating conductor is operable independently of the at least one heating conductor.

36. The image guide device according to claim 33, wherein
the two heating conductors are electrically connected in series via an additional heating conductor, wherein the additional heating conductor is on at least one connector of the two connectors, at least partially surrounds the at least one connector and is in thermal contact with the at least one connector.

37. The image guide device according to claim 1, further comprising
at least one jacket hose, uniformly covering the guide sheath and the at least one heating conductor laterally and arranged for distributing heat from the at least one heating conductor to the guide sheath, wherein the at least one jacket hose has a thermal conductivity of a metallic material and is deformable.

38. The image guide device according to claim 37, wherein
the at least one jacket hose comprises a metal braid.

39. The image guide device according to claim 1, further comprising
at least one temperature sensor configured for detecting a temperature of the image capture device.

40. The image guide device according to claim 1, further comprising
a supplementary heating device, comprising a temperable working gas, configured for heating at least one peripheral component of the image guide device.

41. The image guide device according to claim 1, wherein
the heating conductor device is configured for heating the fiber optic bundle to the treatment temperature in a range of 100 °C to 300 °C.

42. The image guide device according to claim 1, wherein
the guide sheath has a thermal conductivity of a metallic material.

43. The image guide device according to claim 1, further comprising
at least one transparent plate arranged at at least one end of the fiber optic bundle, adjacent to at least one of an input/output window of the fiber optic bundle and an optic, such that the at least one of the input/output window and the optic is protected from fogging when the fiber optic bundle is heated.

44. A method for manufacturing the image guide device according to claim 1, comprising the steps:
providing the fiber optic bundle and the guide sheath for accommodating the fiber optic bundle;
positioning the fiber optic bundle within the guide sheath;
providing the two connectors for connection to the fiber optic bundle;
positioning the at least one heating conductor along the length of the guide sheath; and
connecting each of the connectors to one of the two ends of the fiber optic bundle and a respective end of the guide sheath.

45. The method according to claim 44, further comprising the steps
positioning at least one additional heating conductor, which at least partially surrounds at least one connector of the two connectors and is in thermal contact with the at least one connector.

46. The method according to claim 44, further comprising the steps
providing at least one jacket hose having a thermal conductivity of a metallic material and being elastic; and
covering the guide sheath, the fiber optic bundle, and the at least one heating conductor, which is provided for heating the fiber optic bundle, with the at least one jacket hose, such that the at least one jacket hose uniformly covers the at least one heating conductor for a distribution of heat from the at least one heating conductor to the guide sheath.

47. The method according to claim 44, further comprising the steps
attaching at least one temperature sensor configured for detecting the temperature of the image guide device.

48. The method according to claim 44, wherein the covering of the guide sheath, the fiber optic bundle, and the at least one heating conductor with the jacket hose comprises
mounting the jacket hose on an auxiliary tube having an inner diameter larger than an outer diameter of the assembly of the guide sheath, the fiber optic bundle, and the at least one heating conductor;
positioning the guide sheath with the fiber optic bundle and the at least one heating conductor in the auxiliary tube; and
retracting the auxiliary tube from the guide sheath with the fiber optic bundle and the at least one heating conductor, while the jacket hose remains on the guide sheath, the fiber optic bundle, and the at least one heating conductor.

49. The method according to claim 44, further comprising the steps
attaching at least one retaining clip to the image guide device, the at least one retaining clip being made of an electrically and thermally insulating material at its contact points with the image guide device; and
attachment of the at least one retaining clip to at least one peripheral component of the heating conductor device.

50. A method for regenerating the image guide device according to claim 1, comprising the step
heating the fiber optic bundle via the heating conductor device to the treatment temperature so that radiation-induced material defects in the fiber optic bundle are reduced by heating to the treatment temperature in a range of 100 °C to 300 °C.

51. The method according to claim 50, further comprising the steps
heating a working gas via a supplementary heating device to a temperature in the range of 100 °C and 400 °C to provide a heated working gas; and
supplying at least one peripheral component of the image guide device with the heated working gas.
